(19) United States
(12) Patent Application Publication
(10) Pub. No.: US 2026/0150155 A1
(43) Pub. Date: May 28, 2026

(54) METHODS OF HANDLING PSAP CALL BACKS DURING ONGOING EMERGENCY CALL

(71) Applicant: T-Mobile Innovations LLC, Overland Park, KS (US)

(72) Inventor: Manikanta Kumar Teja PENUMATSHA, Redmond, WA (US)

(21) Appl. No.: 18/978,203

(22) Filed: Dec. 12, 2024

Related U.S. Application Data
(60) Provisional application No. 63/724,869, filed on Nov. 25, 2024.

(51) Int. Cl. H04W 76/50; H04L 65/1016; H04L 65/1104; H04M 3/523

(52) U.S. Cl. CPC H04W 76/50; H04L 65/1016; H04L 65/1104; H04M 3/5231

(57) ABSTRACT

Methods are provided for preventing emergency callbacks to a wireless device. A first emergency call session is established between a public safety access point (PSAP) and a wireless device. After the first emergency call session between the wireless device and the PSAP has ended, the PSAP attempts to callback the wireless device. It is determined that the wireless device is connected to a second emergency call. A session initiation protocol (SIP) signaling message is transmitted to the PSAP that the wireless device is connected to the second emergency call to stop unneeded callbacks to the wireless device.

### PRIORITY

This patent application claims benefit of U.S. Provisional Application Ser. No. 63/724,869, filed on Nov. 26, 2024, which is incorporated by reference in its entirety for all purposes.

### TECHNICAL BACKGROUND

Cellular phones, such as smartphones, are often used for contacting emergency services. In some instances, the emergency service is contactable by a public safety answering point (PSAP). If an emergency call ends abruptly, the PSAP may try to callback. This call may be from the PSAP or may be from a particular emergency service. However, in the meantime the PSAP may be unaware that the user of the cellular phone may have placed another emergency call.

### OVERVIEW

Exemplary embodiments described herein include methods, systems, and devices for preventing emergency callbacks. A callback is received from a public safety access point (PSAP) after a first emergency call session between a wireless device and PSAP has ended. It is determined that the wireless device is connected to a second emergency call. A session initiation protocol (SIP) signaling message is transmitted to the PSAP that the wireless device is connected to the second emergency call.

Additional embodiments here include methods, systems and devices for transmitting SIP signaling messages to a PSAP. A first emergency call session between a PSAP and a wireless device is established. A callback is received from the PSAP after the first emergency call session between the wireless device and the PSAP has ended. It is determined that the wireless device is connected to a second emergency call. A session initiation protocol (SIP) signaling message is transmitted to the PSAP that the wireless device is connected to the second emergency call.

Other embodiments herein include methods, systems and devices for preventing emergency callbacks. A first emergency call session is established between a first PSAP and a wireless device. The first emergency call session between the first PSAP and the wireless device is ended and a second emergency call session is established with a second PSAP. A callback is received from the first PSAP after the first emergency call session between a wireless device and the first PSAP has ended. It is determined the wireless device is connected to the second emergency call session. Responsive to the determination, a SIP signaling message is transmitted to the first PSAP that the wireless device is connected to the second emergency call session.

Another example method includes initiating an emergency call session between a wireless device and a PSAP. The method further receiving from the PSAP a SIP signaling message containing an emergency callback number. Upon receiving the SIP signaling message, the method includes updating a recognized call number list of the wireless device, where updating the recognized call number list comprises identifying the emergency callback number as a recognized emergency number. The method then includes ending the emergency call session. Once the emergency call session has ended, the method includes receiving a call from the emergency callback number. The method then further includes identifying, at the wireless device, the emergency callback number as a recognized emergency number in response to receiving the call.

A further example method identifying and prioritizing an emergency callback includes initiating an emergency call session between a public safety access point (PSAP) and a wireless device. The method then includes receiving a SIP signaling message containing a first emergency callback number from the PSAP. Once the SIP signaling message has been received, the method includes updating a recognized call number list of the wireless device. Updating the recognized call number list includes identifying the first emergency callback number as a recognized emergency number. The method then includes ending the emergency call session. The method further includes receiving, at the wireless device, an updated SIP signaling message, with the updated SIP signaling message containing a second emergency callback number.

### BRIEF DESCRIPTION OF THE DRAWINGS

FIG. 1 illustrates an exemplary environment for wireless device communication in accordance with disclosed embodiments.

FIG. 2 illustrates an exemplary system for wireless device communication with a PSAP in accordance with disclosed embodiments.

FIG. 3 illustrates an additional exemplary system for wireless device communication with a PSAP in accordance with disclosed embodiments.

FIG. 4 illustrates an example method for identifying and prioritizing emergency callbacks in accordance with disclosed embodiments.

FIG. 5 illustrates an exemplary computer device in accordance with disclosed embodiments.

### DETAILED DESCRIPTION

When an emergency call, such as a call to 911, is made, a public safety access point (PSAP) receives the call. The PSAP is connected to a variety of emergency services, such as police, fire, and emergency medical service (EMS), and as such, the PSAP is able to coordinate aid to the caller based on information collected during the emergency call.

In some instances, after the initial call is completed, the first PSAP or a particular emergency service may need to initiate a callback to the wireless device. If the call ends abruptly, due to connection issues or emergency issues, the PSAP may attempt to callback to check on the user of the wireless device. However, if wireless device has made another emergency 911 call after the first call has ended, a “SIP 486” response indicating the wireless device is busy is sent to the first PSAP. This creates confusion, as the first PSAP is unaware that the wireless device is on another emergency call and might continue trying to reach the user, taking up time and services from other callers needing assistance.

Methods and systems provided leverage SIP 486 and SIP 600 messages with custom fields to indicate that the user is engaged in another 911 call. When a user places a second E911 call and the first PSAP tries to callback, the network sends a message indicating that the wireless device is connected to an emergency call rather than the default “user busy” response. The customized SIP messages may include a SIP 486 message “SIP 486—User on Another E911 Call”, instead of sending the default “SIP 486—Busy Here” message or SIP 600 message “SIP 600—User on Another E911 call” instead sending the standard “SIP 600—Busy Everywhere” message.

Additional SIP customizations may include a custom header field included in the SIP message indicating the “X-E911-Status” of the wireless device to ensure the PSAP operator clearly understands the situation. This customization to the SIP message explicitly states the user's current E911 status. This field is visible to the PSAP operator on their screen, providing them with vital information to avoid unnecessary callbacks.

PSAPs have better visibility into the status of the wireless device, avoiding unnecessary callback attempts while the wireless device is engaged in another emergency call. In addition, the first PSAP will be notified that the wireless device is engaged in another emergency call, reducing the likelihood of multiple callback attempts and potential delays in emergency response. By notifying the first PSAP that the user is on another 911 call, resources can be better managed, allowing PSAPs to focus on other emergencies.

The wireless device is not interrupted by multiple attempts of the first PSAP trying to callback, such that the new emergency call is not disrupted. The systems and methods discussed herein facilitate improved PSAP efficiency and enhance caller safety during critical situations.

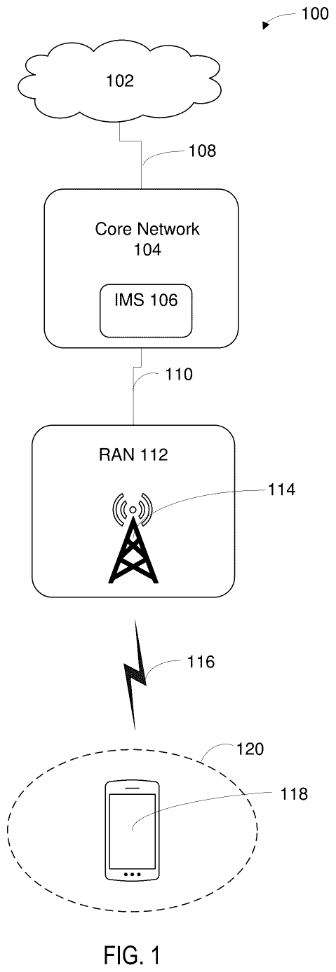

These and other examples will be described in greater detail below in relation to FIGS. 1-5.

FIG. 1 depicts an exemplary system 100 for wireless communication. System 100 includes a communication network 102, a core network 104 and a radio access network (RAN) 112, including at least one access node 114. The RAN 112 may include other devices and additional access nodes. Although one access node is shown, any number of access nodes may be included.

System 100 also includes a wireless device 118, which may be an end-user wireless device and may operate within a coverage area 120. The wireless device 118 may communicate with an access node 114 within the RAN 112 over a communication link 116.

Communication network 102 can be a wired and/or wireless communication network, and can comprise processing nodes, routers, gateways, and physical and/or wireless data links for carrying data among various network elements, including combinations thereof, and can include a local area network a wide area network, and an internetwork (including the Internet). Communication network 102 can be capable of carrying data, for example, to support voice, push-to-talk, broadcast video, and data communications by wireless device 118. Wireless network protocols can comprise Fifth Generation mobile networks or wireless systems (4G or 4G LTE) or 5G. Wired network protocols that may be utilized by communication network 102 comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). Communication network 102 can also comprise additional base stations, controller nodes, telephony switches, internet routers, network gateways, computer systems, communication links, or some other type of communication equipment, and combinations thereof.

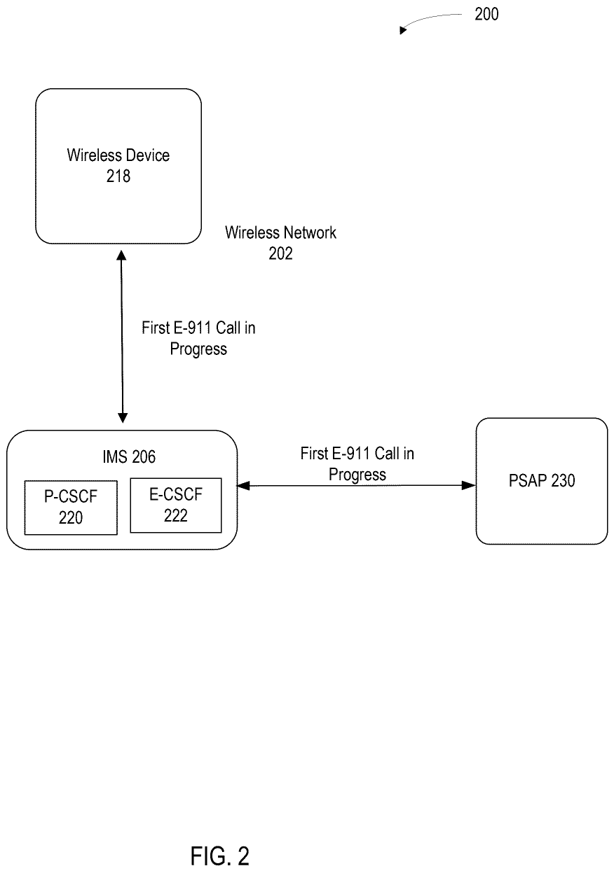

The core network 104 includes the IP Multimedia Subsystem (IMS) 106, which will be explained further in relation to FIG. 2. The core network 104 may be separated into user plane functions and control plane functions. The user plane accesses a data network, such as network 102, and performs operations such as packet routing and forwarding, packet inspection, policy enforcement for the user plane, quality of service (QoS) handling, etc. The control plane handles radio-specific functionality that depends on the idle or connected states of the wireless device 118.

Core network 104 may include an IP multimedia subsystem (IMS) 106. IMS 106 as used herein is a framework used for delivering IP multimedia services, such as voice over internet protocol (VoIP) and/or other similar services, across a network. IMS 106 may include a call session control function (CSCF). The CSCF as used herein is a component of IMS 106 used for session control, signaling and routing in multimedia communication. In embodiments, the CSCF may be used for handling session initiation protocol (SIP) communication. In embodiments, IMS 106 may be used for communication between entities or components of network 102 and wireless device 118. For example, the CSCF of the IMS 106 may be used for transmitting SIP communication to wireless device 118 and a PSAP. Communication links 108 and 110 can use various communication media, such as air, space, metal, optical fiber, or some other signal propagation path-including combinations thereof. Communication links 108 and 110 can be wired or wireless and use various communication protocols such as Internet, Internet protocol (IP), local-area network (LAN), S1, optical networking, hybrid fiber coax (HFC), telephony, T1, or some other communication format-including combinations, improvements, or variations thereof. Wireless communication links may use electromagnetic waves in the radio frequency (RF), microwave, infrared (IR), or other wavelength ranges, and may use a suitable communication protocol, including 4G including 4G NR or 4G Advanced, 6G, NTN, or combinations thereof.

Communication links 108 and 110 can be direct links or might include various equipment, intermediate components, systems, and networks, such as a cell site router, etc. Communication links 108 and 110 may comprise many different signals sharing the same link.

The RAN 112 may include an access network system and device such as access node 114. The RAN 112 is disposed between the core network 104 and the end-user wireless device 118. Components of the RAN 112 may communicate directly with the core network 104 and others may communicate directly with the end user wireless device 118. The RAN 112 may provide services from the core network 104 to the end-user wireless device 118.

The RAN 112 includes an access node (or base station) 114, which may include one or more access nodes communicating with the end-user wireless device 118. It should be understood that the disclosed technology may also be applied to communication between an end-user wireless device and other network resources, such as relay nodes, controller nodes, antennas, etc. The RAN 112 may further comprise a non-terrestrial network (NTN) serving the multiple UEs by a radio frequency transmission provided by utilizing orbiting satellites that may be in communication with access nodes of a terrestrial network (TN). The satellites may include geosynchronous equatorial orbit (GEO) satellites, Medium Earth Orbit (MEO) satellites, and low Earth orbit (LEO) satellites. The NTN may include NTN nodes that are not stationed on the ground.

Access node 114 can be, for example, standard access nodes such as a macro-cell access node, a base transceiver station, a radio base station, an evolved NodeB (or eNodeB) in 4G or 4G LTE, a next generation NodeB (or gNodeB) in 5G New Radio (“5G NR”), or the like. In additional embodiments, access nodes may comprise two co-located cells, or antenna/transceiver combinations that are mounted on the same structure. Alternatively, access node 114 may comprise a short range, low power, small-cell access node such as a microcell access node, a picocell access node, a femtocell access node. Access node 114 can be configured to deploy one or more different carriers, utilizing one or more RATs. Any other combination of access nodes and carriers deployed therefrom may be evident to those having ordinary skill in the art in light of this disclosure.

The access node 114 and servers in the IMS 105 may comprise a processor and associated circuitry to execute or direct the execution of computer-readable instructions. They may retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

The wireless device 118 may include any wireless device included in a wireless network. Wireless device 118 may include any device configured to send and receive messages over SIP. For example, the term “wireless device” may include a relay node, which may communicate with an access node. The term “wireless device” may also include an end-user wireless device, which may communicate with the access node through a relay node. The term “wireless device” may further include an end-user wireless device that communicates with the access node directly without being relayed by a relay node. Wireless device 118 may be any device, system, combination of devices, or other such communication platform capable of communicating wirelessly with access node 114 using one or more frequency bands and wireless carriers deployed therefrom. Wireless device 118 may be, for example, a mobile phone, a wireless phone, a wireless modem, a personal digital assistant (PDA), a voice over internet protocol (VoIP) phone, a voice over packet (VOP) phone, or a soft phone, a wearable device, an internet of things (IoT) device, as well as other types of devices or systems that can send and receive audio or data. The wireless device 118 may be or include high power wireless devices or standard power wireless devices.

System 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork (including the Internet). Communication system 100 may be capable of communicating signals and carrying data, for example, to support voice, push-to-talk, broadcast video, and data communications by end-user wireless device 118.

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements, e.g., between the RAN 112 and the core network 104.

Although one core network 104 is shown, multiple core networks 104 may be utilized. Alternatively, the single core network 104 may include a distributed, cloud-native, converged core gateway. Thus, the converged core gateway could connect a 4G LTE evolved packet core (EPC) to a 5G core network.

Communication links 108 and 110 can use various communication media, such as air, space, metal, optical fiber, or some other signal propagation path, including combinations thereof. Communication links 108 and 110 can be wired or wireless and use various communication protocols such as Internet, Internet protocol (IP), local-area network (LAN), S1, optical networking, hybrid fiber coax (HFC), telephony, T1, or some other communication format-including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, 6G or combinations thereof. Other wireless protocols can also be used. Communication links 108 and 110 can be direct links or might include various equipment, intermediate components, systems, and networks, such as a cell site router, etc. Communication links 108 and 110 may comprise many different signals sharing the same link.

The methods, systems, devices, networks, access nodes, and equipment described herein may be implemented with, contain, or be executed by one or more computer systems and/or processing nodes. The methods described above may also be stored on a non-transitory computer readable medium. Many of the elements of system 100 may be, comprise, or include computers systems and/or processing nodes, including access nodes, controller nodes, and gateway nodes described herein.

The operations for preventing emergency callbacks may be implemented as computer-readable instructions or methods, and processing nodes on the network and/or computing device, such as end user wireless device, for executing the instructions or methods. The processing node may include a processor included in the access node or a processor included in any controller node in the wireless network that is coupled to the access node. The computing device may include at least a processor and a memory with instructions configuring the processor to execute instructions.

Now referring to FIG. 2, an exemplary system 200 for notifying a PSAP using SIP that a wireless device is connected to an emergency call is presented. System 200 includes a wireless device 218. Wireless device 218 may be the same as wireless device 118. System 200 also includes wireless network 202. Wireless network 202 may include a RAN, core network and/or a communication network, which may be the same as, respectively, RAN 112, core network 104 and communication network 102. In some examples, wireless network 202 may be hosted by a mobile network operator (MNO).

The IMS 206 includes may include servers, including a proxy call session control function (P-CSCF) 220 and an emergency call session control function (E-CSCF) 222, shown, but it should be understood that there are many other types of IMS and core servers that are omitted for clarity. A proxy server, such as P-CSCF 220 receives a first emergency call request from a wireless device. Headers may be added to the call request in the form of SIP headers such as Resource Priority Header (RPH), X-MAV-RPH:911, Orig. ID, and Attestation-Info identifying the call as an emergency call. The call request may then be forwarded to an emergency call management server such as E-CSCF 222 for further processing. E-CSCF 222 may query a gateway mobile location center (GMLC) for information about the destination network of the call. E-CSCF 222 maintains information regarding the call such as the calling and receiving phone numbers, the start and end time of the call, the duration of the call, and the cell towers used during the connection.

The GMLC returns information on a public safety access point (PSAP) 230 that services the location of the wireless device that originated the call request. This information includes how to connect the PSAP 230. The wireless device 218 is then connected to the PSAP 230. PSAP 230 may use SIP trunking to connect to IMS 206, which allows PSAP 230 to send and receive voice and multimedia data over an IP network. PSAP 230 may use SIP and session description protocol (SDP) for managing session and session parameters.

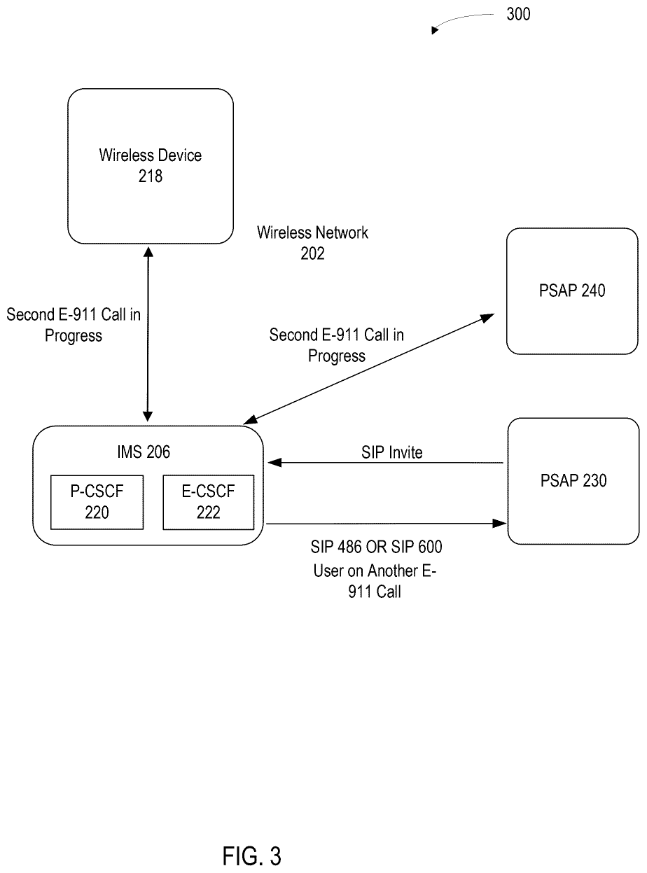

Now referring to FIG. 3, an exemplary system 300 for notifying a PSAP using SIP that a wireless device is connected to an emergency call is presented. Like FIG. 2, system 300 includes a wireless device 218. Wireless device 218 may be the same as wireless device 118. System 300 also includes wireless network 202. Wireless network 202 may include a RAN, core network and/or a communication network, which may be the same as, respectively, RAN 112, core network 104 and communication network 102. In some examples, wireless network 202 may be hosted by a mobile network operator (MNO).

The IMS 206 includes may include servers, including a proxy call session control function (P-CSCF) 220 and an emergency call session control function {E-CSCF) 222. E-CSCF 222 maintains information regarding the call such as the wireless device phone number and identification, the emergency call information, the start and end time of the call, the duration of the call, and the cell towers used during the connection.

FIG. 3 depicts that the first emergency call session between PSAP 230 and wireless device 218 of FIG. 2 has ended due to network issues or was prematurely ended by the caller. The PSAP 230 may attempt to callback to check on the user of the wireless device. PSAP 230 may attempt to callback wireless device 218 using a SIP Invite or a fallback connection.

The wireless device 218 initiated a second emergency (E-911) call and is now in connection with PSAP 240. While PSAP 230 and 240 are depicted as separate PSAPs, it will be appreciated that PSAP 230 and 240 may be a single PSAP with multiple call operators. In this embodiment, one call operator of the PSAP may be connected with the wireless device while another call operator of the PSAP is attempting to callback the wireless device.

When attempting to connect the second emergency call, IMS 206 is able to determine that wireless device 218 is currently connected with PSAP 240 as the E-CSCF 222 has maintained information regarding the first and second emergency calls such as the wireless device phone number and identification, the emergency call information, the start and end time of the call, the duration of the call, and the cell towers used during the connection.

The IMS 206 generates a SIP signaling message. The SIP signaling message may be a SIP BYE, “SIP 486” or a “SIP 600” signaling message to notify PSAP 230 attempting to callback wireless device 218, that wireless device 218 is engaged in another emergency (E911) call. IMS 206 generates and transmits a message indicating that wireless device 218 is connected to PSAP 240 rather than the default “user busy” response. Exemplary customized SIP messages may include “SIP 486-User on Another E911 Call” or “SIP 600—User on Another E911 call.”

IMS 206 may make additional SIP customizations including a custom header field included in the SIP message indicating the “X-E911-Status” of wireless device 218 to PSAP 230. This customization to the SIP message explicitly states the current E911 status of wireless device 218 thus allowing PSAP 230 to discontinue callbacks to wireless device 218.

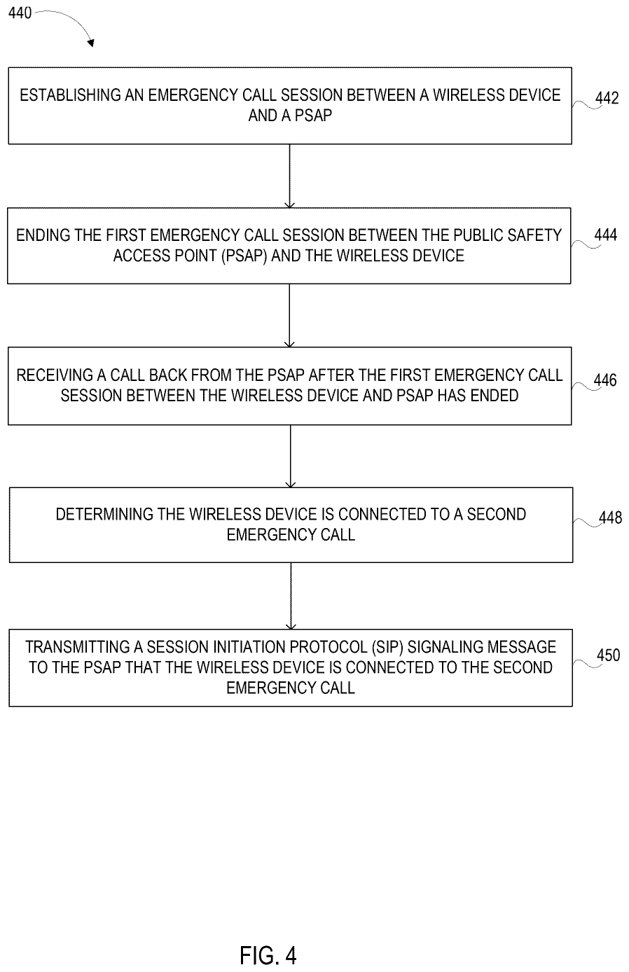

FIG. 4 illustrates another example method 440 for identifying and prioritizing emergency callbacks in accordance with disclosed embodiments. Method 440 may be performed by any suitable combination of processors discussed herein, for example a processor contained in an emergency call management server, such as an E-CSCF server.

Method 440 begins at step 442 where an emergency call session is initiated between a PSAP and a wireless device. The emergency call session may be transmitted via a wireless network, which may be hosted by a mobile network operation (MNO). In some examples, the emergency call is a session initiation protocol (SIP) invite. In embodiments, the CSCF transmits an SIP INVITE from the wireless device to the PSAP or vice versa. In embodiments, the SIP INVITE may include session description protocol (SDP) parameters that establishes an IP multimedia subsystem data channel (IMS DC) for the session.

Method 440 continues in step 444 with the ending of the emergency call session between the wireless device with the PSAP. In some examples, the emergency call session is ended due to network issues or early termination at the wireless device due to emergency conditions.

At step 446, method 440 includes receiving a callback from the PSAP after the first emergency call session between the wireless device and PSAP has ended. The PSAP to callback wireless device 218 using a SIP Invite or a fallback connection after the first emergency call session has ended. In the meantime, the wireless device initiated a second emergency (E-911) call and is now in connection.

Method 440 continues at step 448 to determine the wireless device is connected to a second emergency call. Information from the headers of the SIP signaling messages from the first emergency call, the second emergency call and the callback are maintained by E-CSCP of the IMS of the network. The information maintained by the E-CSCP is queried when callback is received to determine if the wireless device the PSAP is attempting to callback is connected to another emergency call. The phone number and device information from the first and second emergency calls and the callback from the PSAP from the E-CSCP and it is determined that the first and second emergency calls and the callback all relate to the same wireless device that is currently connected on the second emergency call.

Based on this determination, method 440 continues at step 450 and transmits a session initiation protocol (SIP) signaling message to the first PSAP indicating that the wireless device is connected to a second emergency call. The SIP signaling message is transmitted using an IMS DC. The SIP signaling message is generated and transmitted to the first PSAP indicating that the wireless device 218 is connected to a second PSAP rather than the default “user busy” response. Exemplary customized SIP messages may include “SIP 486-User on Another E911 Call” or “SIP 600—User on Another E911 call.” Additional SIP customizations may include a custom header field included in the SIP message indicating the “X-E911-Status” of the wireless device. This customization to the SIP message explicitly states the current E911 status of the wireless device thus allowing the first PSAP to discontinue callbacks to wireless device.

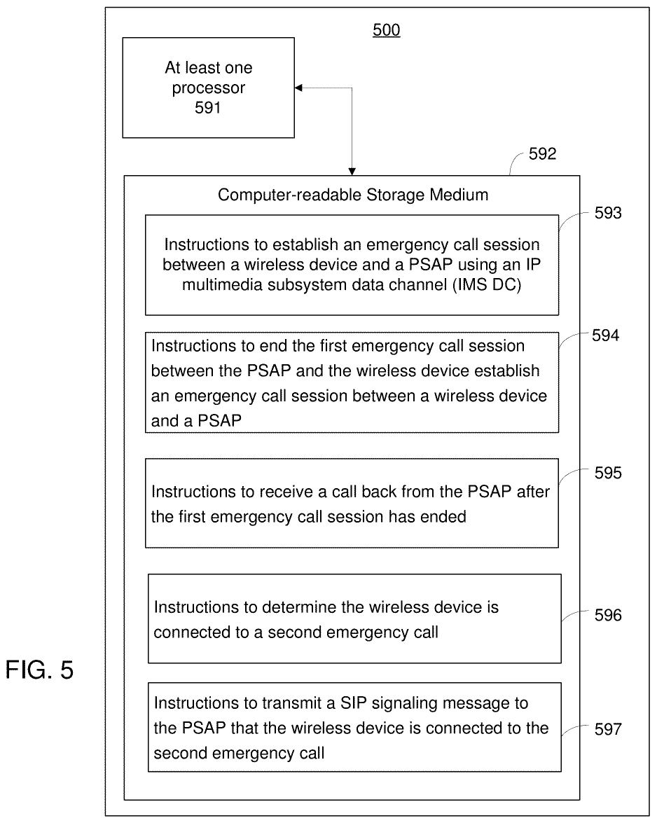

Now referring to FIG. 5, an example computing device 500 is presented. In this example, computing device 500 includes at least one processor 591 communicably coupled to a computer-readable storage medium 592. The at least one processor 591 may include a microprocessor, a microcontroller, one or more central processing unit (CPU) cores, an application-specific integrated circuit (ASIC), one or more graphical processing unit (GPU) cores, a field programmable gate array (FPGA), and/or any other hardware device suitable for retrieval and execution of instructions from computer-readable storage medium 592. In instances, at least one processor 591 may include electronic circuitry for performing instructions described in this disclosure.

In instances, computer-readable storage medium 592 may be any medium suitable for storing executable instructions. In examples, without limitation, computer-readable storage medium 592 may include read-only memory (ROM), random-access memory (RAM), erasable electrically programmable ROM (EEPROM), Solid State Drive (SSD), optical disc, and the like. Computer-readable medium storage 592 may be disposed within computing device 500. In embodiments, computer-readable storage medium 592 may external, and communicably connected, to computing device 500. The instruction stored on computer-readable storage medium may be used to implement method steps described in reference to FIG. 4.

In this example, computer-readable storage medium 592 is encoded with set of instructions 593 and 594. In embodiments, computer-readable storage medium 592 may be further encoded with set of instructions 595, 596, and 597. In embodiments, executable instructions included in each block may be included in different blocks shown and blocks not shown.

Instruction 593, when executed by at least one processor 591, configures the at least one processor 591 to establish an emergency call session between a wireless device and a PSAP using an IP multimedia subsystem data channel (IMS DC).

Instruction 594, when executed by at least one processor 591, configures the at least one processor 591 to end the first emergency call session between the PSAP and the wireless device establish an emergency call session between a wireless device and a PSAP The wireless network may be consistent with, or include, network components described in reference to FIGS. 1 and 2, such as wireless network 202.

In some embodiments, instruction 595, when executed by at least one processor 591, configures the at least one processor 591 to receive a call back from the PSAP after the first emergency call session has ended. In embodiments, instruction 596, when executed by at least one processor 591, configures the at least one processor 591 to determine the wireless device is connected to a second emergency call. In embodiments, instruction 597, when executed by the at least one processor 591 configures the at least one processor 591 to transmit a SIP signaling message to the PSAP that the wireless device is connected to the second emergency call.

In some embodiments, method 440 may include additional steps or operations. Furthermore, the methods may include steps shown in each of the other methods. As one of ordinary skill in the art would understand, the method 440 may be integrated in any useful manner and the steps may be performed in any useful sequence.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices. Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not all be within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method comprising:
receiving a callback from a public safety access point (PSAP) after a first emergency call session between a wireless device and the PSAP has ended;
determining the wireless device is connected to a second emergency call; and
transmitting a session initiation protocol (SIP) signaling message to the PSAP that the wireless device is connected to the second emergency call.

2. The method of claim 1, further comprising:
establishing the first emergency call session between the PSAP and the wireless device;
ending the first emergency call session between the PSAP and the wireless device; and
receiving a callback to the wireless device from the PSAP.

3. The method of claim 2, wherein the SIP signaling message further comprises a current E911 status of the wireless device.

4. The method of claim 3, wherein the SIP signaling message further comprises sending a SIP 486 message to the PSAP.

5. The method of claim 3, wherein the SIP signaling message further comprises sending a SIP 600 message to the PSAP.

6. The method of claim 3, wherein a header of the SIP signaling message contains the current E911 status of the wireless device.

7. The method of claim 1, wherein the SIP signaling message is received via an IP multimedia subsystem data channel (IMS DC).

8. The method of claim 3, wherein the SIP signaling message has an updated X-E911-Status field.

9. A method comprising:
establishing a first emergency call session between a public safety access point (PSAP) and a wireless device;
receiving a callback from the PSAP after the first emergency call session between the wireless device and the PSAP has ended;
determining the wireless device is connected to a second emergency call; and
transmitting a session initiation protocol (SIP) signaling message to the PSAP that the wireless device is connected to the second emergency call.

10. The method of claim 9, wherein the SIP signaling message further comprises a current E911 status of the wireless device.

11. The method of claim 10, wherein a header of the SIP signaling message contains the current E911 status of the wireless device.

12. The method of claim 9, wherein the SIP signaling message is received via an IP multimedia subsystem data channel (IMS DC).

13. The method of claim 11, wherein the SIP signaling message has an updated X-E911-Status field.

14. A method comprising:
establishing a first emergency call session between a first public safety access point (PSAP) and a wireless device;
ending the first emergency call session between the first PSAP and the wireless device;
establishing a second emergency call session with a second PSAP;
receiving a callback from the first PSAP after the first emergency call session between a wireless device and the first PSAP has ended;
determining the wireless device is connected to the second emergency call session; and
transmitting a session initiation protocol (SIP) signaling message to the first PSAP that the wireless device is connected to the second emergency call session.

15. The method of claim 14, wherein the callback from the first PSAP is a SIP invite to the wireless device.

16. The method of claim 14, wherein the SIP signaling message further comprises sending a SIP BYE message to the first PSAP.

17. The method of claim 14, wherein the SIP signaling message further comprises sending a SIP 486 message to the first PSAP.

18. The method of claim 14, wherein the SIP signaling message further comprises sending a SIP 600 message to the first PSAP.

19. The method of claim 16, wherein a header of the SIP signaling message contains the current E911 status of the wireless device.

20. The method of claim 14, wherein the first PSAP and the second PSAP are a single PSAP.
